(19) United States
(12) Patent Application Publication
(10) Pub. No.: US 2005/0172785 A1
(43) Pub. Date: Aug. 11, 2005

(54) Musical instrument

(76) Inventors: Holly E. Fisher-Robbins, Pennsauken, NJ (US); Thomas R. Omstead, Freemont, CA (US); William J. Messner, Mount Morris, NY (US); Cherie Heinz, Pennsauken, NJ (US)

Correspondence Address: FISH & RICHARDSON P.C., P.O. BOX 1022, MINNEAPOLIS, MN, 55440-1022, US

(21) Appl. No.: 10/870,433

(22) Filed: Jun. 18, 2004

Related U.S. Application Data
(60) Provisional application No. 60/540,556, filed on Feb. 2, 2004.

(51) Int. Cl. G10D 1/00; B32B 3/02; F16C 19/00; A63J 17/00

(52) U.S. Cl. 84/464 R; 84/1

(57) ABSTRACT

A musical instrument, such as a guitar, includes a transparent layer, an object formed in the transparent layer, a light source configured to transmit light into the transparent layer to illuminate the object, and a non-transparent layer over the transparent layer. The non-transparent layer is configured to inhibit the object from being seen through the non-transparent layer unless the light source is illuminated. A guitar may also include a neck and a body defining a sealed, hollow cavity that is fillable with a gas, a solid, a liquid, or a vacuum.

### CLAIM OF PRIORITY

This application claims priority under 35 U.S.C. §119(e) to U.S. Patent Application Ser. No. 60/540,556, filed on Feb. 2, 2004, the entire contents of which are hereby incorporated by reference.

### TECHNICAL FIELD

This invention relates generally to a musical instrument and more particularly to a musical instrument capable of producing a visual display.

### BACKGROUND

There are various types of musical instruments, including stringed musical instruments such as guitars and basses, available in the market. In this industry, manufactures and consumers are continually looking for instruments having features that differentiate them from other instruments. This has previously been accomplished, for example, by varying the shape, color, size or material of the musical instrument.

### SUMMARY

In one general aspect, a musical instrument includes a transparent layer, an object formed in the transparent layer, a light source configured to transmit light into the transparent layer to illuminate the object, and a non-transparent layer over the transparent layer. The non-transparent layer is configured to inhibit the object from being seen through the non-transparent layer unless the light source is illuminated.

Implementations can include one or more of the following features.

The musical instrument may be a stringed musical instrument, such as a guitar or a bass. The object may be a groove in the transparent layer, a roughened surface on the transparent layer, a hole in the transparent layer, and/or a solid object embedded in the transparent layer.

The musical instrument may further include an intermediate layer sandwiched between the transparent layer and the non-transparent layer. The intermediate layer may be a gas, a vacuum, a liquid, and/or a solid spacer. The intermediate layer may be configured to inhibit the object from being seen through the non-transparent layer unless the light source is activated.

The non-transparent layer may be composed of a translucent material, a layer of a transparent material with an embedded dye or pigment or a metal or metal oxide coating. The transparent layer includes glass, acrylic, polystyrene, PET, Plexiglas, Lucite, transparent foam, water, rubbing alcohol, or consumable alcohol. The light source may include an LED, an incandescent bulb, a fluorescent bulb, a plasma light source, a candle, a neon light source, a fiberoptic light source, a plasma light source, or an electroluminescent light source such as an electroluminescent sheet, wire, or cable. The musical instrument also may include a removable cartridge that houses the light source. The transparent layer may define a chamber containing a moveable object. The light source may be configured to illuminate the moveable object.

The musical instrument may include an electroluminescent sheet that may be substantially hidden by the non-transparent layer when not activated and visible through the non-transparent layer when activated. The musical instrument may include metallic particulate matter embedded in the transparent layer or the non-transparent layer.

In another aspect, a device may include a transparent layer including an object therein, a light source configured to illuminate the object, and a non-transparent layer over the transparent layer. The non-transparent layer may be configured to inhibit the object from being seen through the non-transparent layer unless the light source is illuminated.

In yet another aspect, a musical instrument may include a transparent layer formed into the body of the musical instrument and an object formed in the transparent layer. A translucent layer may cover the transparent layer with an air gap between the translucent layer and the transparent layer to inhibit the object from being seen through the translucent layer. A light source may be seated in a recess formed in the transparent layer and covered by an opaque surface. The light source may be configured to illuminate the object such that the object can be seen through the translucent layer.

In another aspect, a method of selectively illuminating an object formed in a musical instrument may include providing a body of the musical instrument with a transparent layer having the object formed therein and a non-transparent layer over the transparent layer to inhibit the object from being seen, and illuminating a light source to transmit light into the transparent layer to illuminate the object while limiting illumination of the transparent layer.

In another aspect, a stringed musical instrument may include a neck and a body defining a sealed, hollow cavity that is fillable with a gas, a solid, a liquid, or a vacuum. Implementations of this aspect can include one or more of the following features. The body may include a port in communication with the cavity that allows insertion and removal of the solid, the liquid, or the gas. The guitar may include a tube in communication with the cavity to allow removal of the solid, the liquid, or the gas. The body may include a combustion chamber, a transmission tube in communication with the cavity and the combustion chamber, and a straw in communication with the cavity. The straw allows inhalation of smoke from tobacco or other substance that is burned in the combustion chamber.

In another aspect, a stringed musical instrument may include a neck, a body defining a sealed, hollow cavity filled with a gas, and an electrode within the cavity for exciting the gas to form a plasma.

The details of one or more implementations of the invention are set forth in the accompanying drawings and the description below. Other features will be apparent from the description and drawings, and from the claims.

### DESCRIPTION OF DRAWINGS

FIG. 1 is a perspective view of a guitar having an illuminated portion.

FIG. 2 is an exploded perspective view of an illuminated portion of a body of the guitarof FIG. 1.

FIG. 3 is a perspective view of a transparent layer of the illuminated portion shown in FIG. 2.

FIG. 4 is a cross-sectional view of an illuminated portion of a body of the guitar of FIG.

FIG. 5 is an exploded perspective view of another embodiment of an illuminated portion of a body of the guitar of FIG. 1.

FIG. 6 is a cross-sectional view of another embodiment of an illuminated portion of a body of the guitar of FIG. 1.

FIG. 7 is an exploded perspective view of another embodiment of an illuminated portion of a body of the guitar of FIG. 1.

FIG. 8 is an exploded perspective view of another embodiment of an illuminated portion of a body of the guitar of FIG. 1.

FIG. 9 is a cross-sectional view of an illuminated portion of a body of the guitar of FIG. 1 shown in FIG. 8.

FIG. 10 is a perspective view of another embodiment of a guitar having a sealed hollow cavity.

FIG. 11 is a perspective view of the guitar of FIG. 10 having a port and a straw.

FIG. 12 is a perspective view of the guitar of FIG. 11 having a combustion chamber, a transmission tube, and a straw.

FIG. 13 is an exploded perspective view of another embodiment of a guitar having triode switches for illuminating the fret board.

FIG. 14 is a cross-sectional view of the triode switch of FIG. 13.

FIG. 15 is a circuit diagram of the triode switch of FIG. 13.

FIG. 16A is a top view of an elliptical chamber in the guitar containing an illuminated ball.

FIG. 16B is a top view of a cylindrical chamber in the guitar containing an illuminated ball.

FIG. 16C is a top view of a rectangular chamber in the guitar containing an illuminated pendulum.

FIG. 16D is a perspective view of a cylindrical chamber in the guitar containing an illuminated rod.

FIG. 17 is a perspective view of another embodiment of the guitar of FIG. 1.

### DETAILED DESCRIPTION

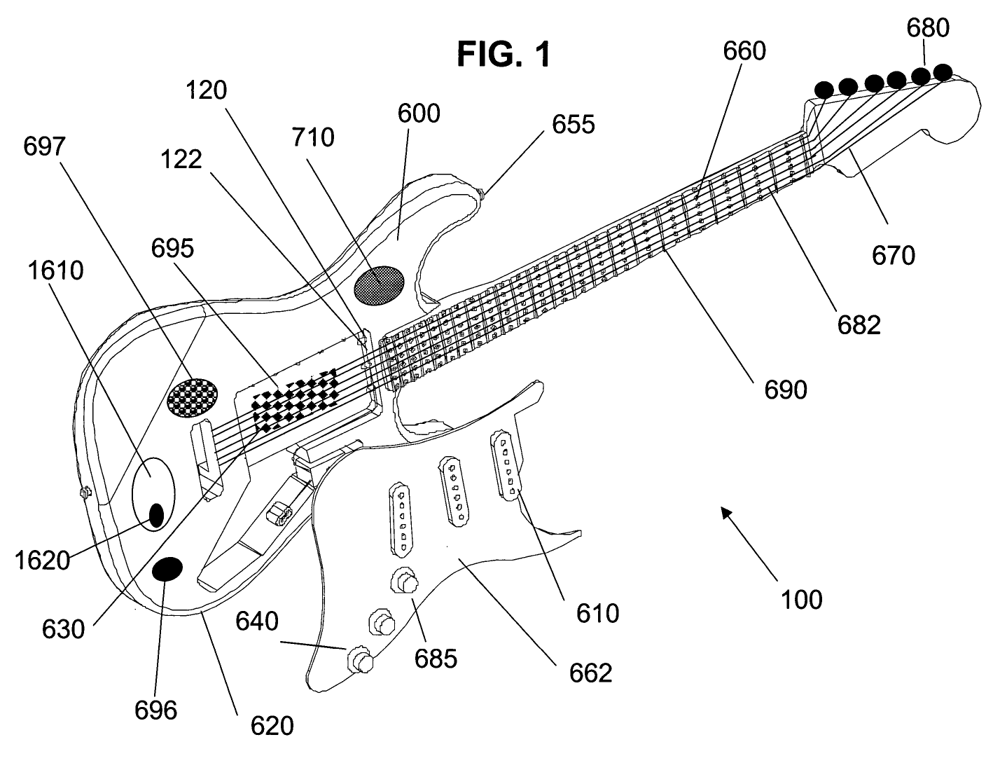

Referring to FIG. 1, a guitar 100 includes a body 600, a neck 660, a head 670, and a strap holder 655. Strings 682 are attached to head 670 by tuning pegs 680 that adjust the tension of strings 682 so as to adjust the resonance frequency associated with each string 682. Strings 682 run along neck 660 to body 600 where strings 682 are coupled to body 600. When guitar 100 is played, e.g., by actuating one or more of strings 682, body 600 resonates with vibration of strings 682 producing a sound. Coupled to neck 660 are frets 690, whereby placing fingers on frets 690 adjusts the effective length of strings 682, which creates different pitch or tone. Body 600 also includes an optional pick guard 662 and one or more pickups 610. Each pick-up 610 is an induction coil for an electromagnet that detects movement of strings 682 as strings 682 alter the magnetic field generated by the pickup 610. Coupled to body 600 are active and passive electronics (not shown) in an electronics bay 630, a tone control knob 640 and a volume control knob 685, which together allow for amplification and/or modification of the sound generated by strings 682.

Formed in body 600 are a variety of objects including a pattern 695, embedded particles 697, an embedded object 696, and a chamber 1610 containing a moveable object 1620. Located in electronics bay 630 is a light source 120, contained in a removable cartridge 122, that can illuminate these or other objects. As explained further herein, these, and other, objects cannot be seen in body 600 until light source 120 is activated to illuminate these objects.

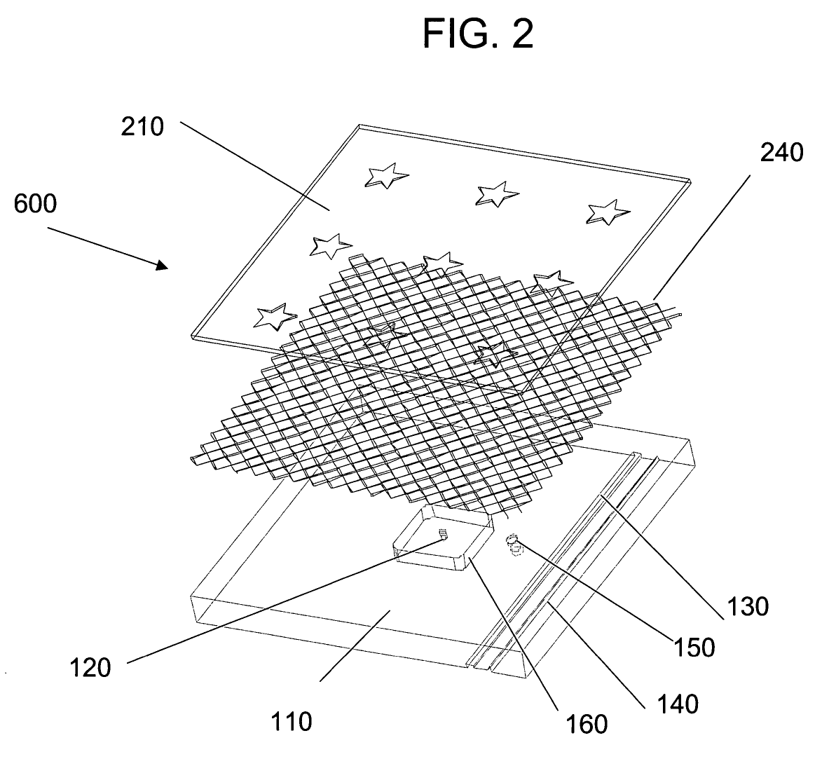

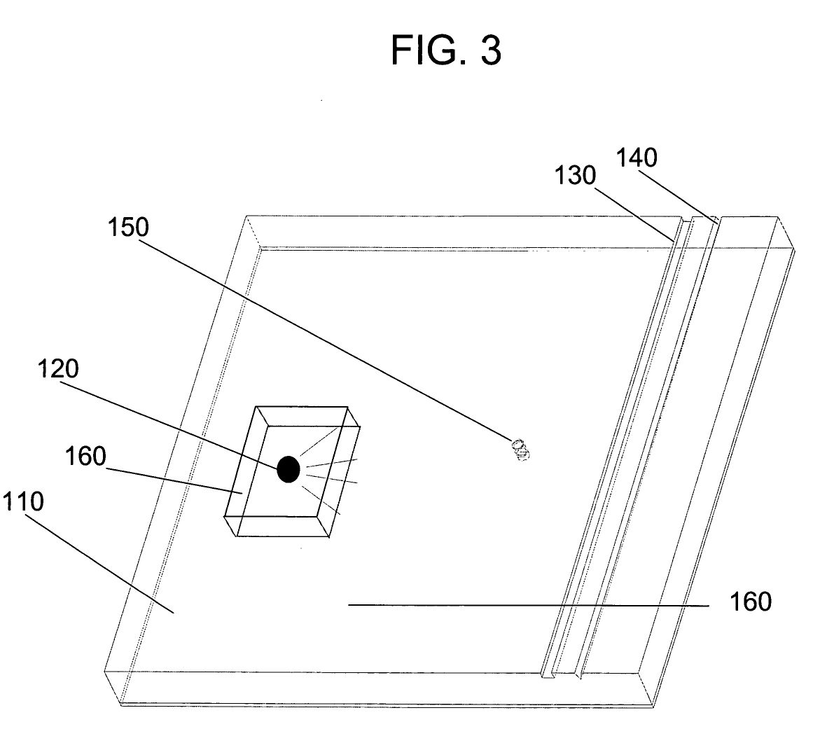

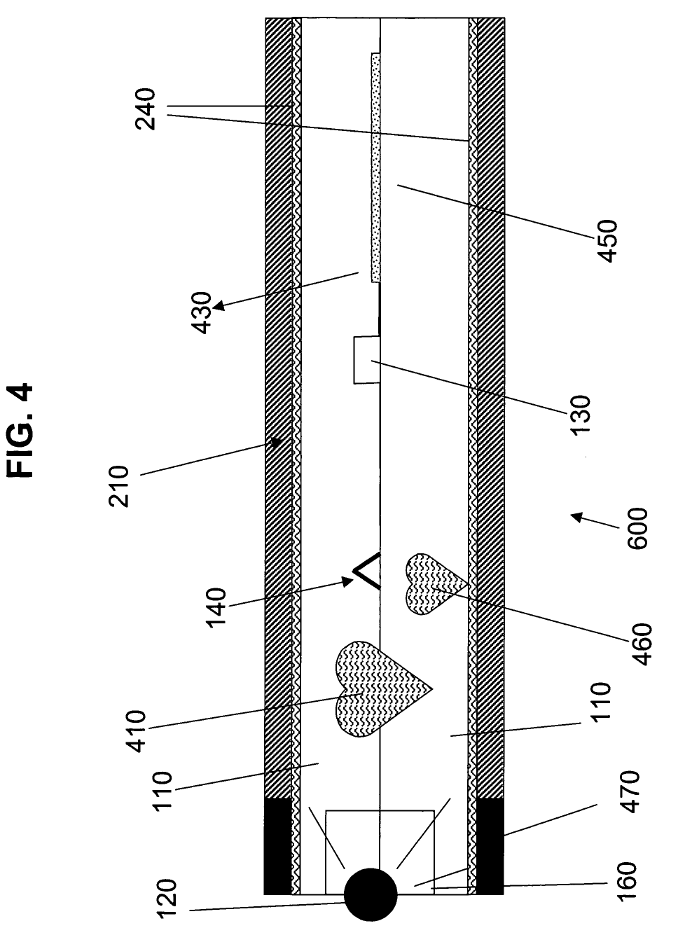

Referring to FIGS. 2-4, a portion of body 600 of guitar 100 is shown. Body 600 includes a transparent layer 110, in which objects are formed objects, e.g., a V-groove 140, a square groove 130, a drilled hole 150, an object 410, and a roughened surface 460. On either side of transparent layer 110 is a non-transparent layer 210, which may include a translucent, patterned, or one-way reflective surface, which inhibits V-groove 140, square groove 130, object 410, and roughened surface 460 from being seen through the non-transparent layer 210 when light source 120 is not illuminated. Sandwiched between transparent layer 110 and non-transparent layer 210 is an intermediate layer 240, which may include a nylon mesh, or an air gap, which inhibits non-transparent layer 210 from being directly illuminated by the transmission of light through transparent layer 110. Intermediate layer 240 inhibits V-groove 140, square groove 130, object 410, and roughened surface 460 from being seen through the non-transparent layer 210 when light source 120 is not illuminated, while allowing V-groove 140, square groove 130, object 410, and roughened surface 460 to be visible through non-transparent layer 210 when light source 120 is illuminated.

When light source 120 is not illuminated, V-groove 140, square groove 130, object 410, and roughened surface 460 within transparent layer 110 are substantially hidden from sight and only the patterns or reflective surface of non-transparent surface 210 is visible. When light source 120 is illuminated, light is transmitted laterally through the transparent layer 110. Transparent layer 110 is only slightly illuminated, as the higher index of refraction of the transparent layer 110 as compared to air (e.g., about 1.2 to 1.4) inhibits light from escaping from transparent layer 110. When light hits one or more of V-groove 140, square groove 130, object 410, and roughened surface 460, the light is refracted or reflected, and thus, redirected, so that the light escapes transparent layer 110 and is transmitted through intermediate layer 240 and non-transparent layer 210 into the air, thus illuminating the objects. Thus, when light source 120 is illuminated, the designs in V-groove 140, square groove 130, object 410, and roughened surface 460 can be seen through non-transparent layer 210. V-groove 140, square groove 130, object 410, and roughened surface 460 appear as if they are being projected onto the outer surface of body 600 from an external light source.

Light source 120 is disposed within a recess 160 in transparent layer 110 and is covered on either side by an opaque layer 470. Light source 120 can be any suitable light source, such as an LED, an incandescent bulb, a fluorescent bulb, a plasma light source, a candle, a neon light source, a fiber optic light source, a plasma light source, or an electroluminescent light source such as an electroluminescent sheet, wire, or cable. The transparent layer 110 can be made from any suitable, substantially transparent material, such as glass, acrylic, polystyrene, PET, Plexiglas®, Lucite®, transparent foam, or water, rubbing alcohol, or consumable alcohol encased in glass. Non-transparent layer 210 can be any translucent material that selectively allows light pass through when directly illuminated from behind, such as sand-blasted Plexiglas, frosted glass, plastic, or a thin metal or metal oxide coating. The non-transparent layer 210 can be translucent, or can have embedded dyed or particles, a metallic coating, or a patterned or roughened surface. Intermediate layer 240, which may be optional, can include any suitable material such as a nylon mesh, or transparent or semi-transparent solid, liquid, or gas, e.g., air, argon, helium, neon, or nitrogen, or can be formed by a discontinuity or non-hermetic interface between transparent layer 110 and non-transparent layer 210. Intermediate layer 240 can have a small or microscopic thickness. Intermediate layer 240 can be advantageous for use with a non-transparent layer that includes a roughened or patterned surface, such as shown in FIG. 2.

V-groove 140 and square groove 130 are formed in transparent layer 110 by, e.g., molding, etching, machining, or cutting. A groove or other design can be formed in the interior of transparent layer 110 such as by applying a laser to deform the interior of transparent layer 110. Roughened surface 460 is formed in transparent layer, e.g., by cutting, etching, sandblasting, or applying heat or laser energy. Object 410 is embedded into transparent layer, e.g., by placing the object into the liquid resin used to form transparent layer, pouring liquid resin into a suitable mold, and allowing the resin to cool. Multiple objects can be embedded in the transparent layer. For example, diamonds or other gemstones can be mixed into liquid acrylic and then the liquid acrylic can be poured into a mold shaped like the guitar body.

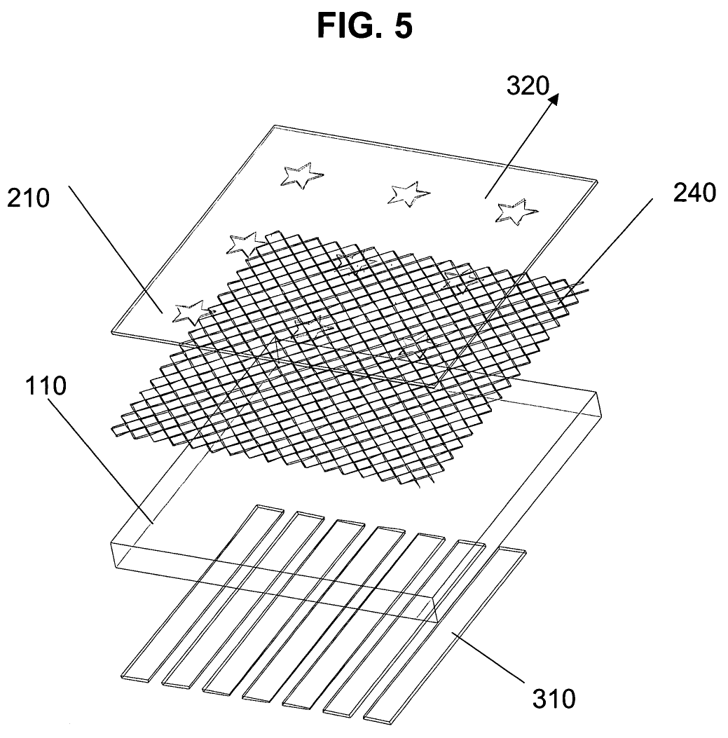

Referring to FIG. 5, in another implementation, a patterned electroluminescent sheet 310 is embedded underneath or within transparent surface 110. Electroluminescent sheet 310 is composed, for example, of a very thin layer of light emitting phosphor placed between two thin electrodes. One electrode is opaque and the other electrode is translucent to allow light to escape. When current is applied to the electrodes, the phosphor rapidly charges and discharges, resulting in the emission of light. The brightness and color of the light depends on the chemical composition and dye pigments of the phosphor. Electroluminescent sheet 310 can be cut into a suitable pattern, such as letters or pictures. Electroluminescent sheet 310 is substantially hidden from view by non-transparent layer 210, and intermediate layer 240 until electroluminescent sheet 310 is activated to radiate light. in the direction of arrow 320.

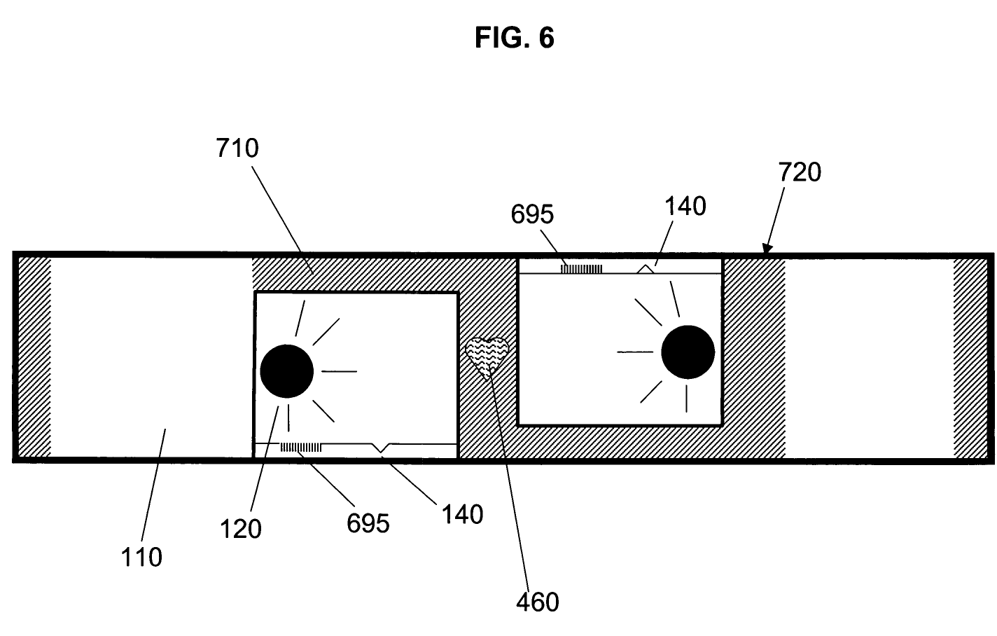

Referring to FIG. 6, in another implementation, transparent layer 110 includes a dyed portion 710 in which a dye has been embedded. As shown in FIG. 6, dyed portion 710 inhibits roughened pattern 695 or V-groove 140 from being seen unless light source 120 is illuminated. In this implementation, when light source 120 is illuminated, dyed portion 710 also is illuminated so that V-groove 140 and roughened portion 695 will appear to take on the color of the dye. Dyed portion 710 may be covered by a reflective layer 720, e.g., a metallic layer or a layer of transparent material with embedded metallic particles, which provides for additional obscuring of V-groove 140 and roughened portion 695 until V-groove 140 and roughened portion 695 are illuminated by light source 120. Object 460 is embedded in the dyed portion 710 and illuminated by light source 120. Dyed portion 710 also can be embedded with particulate micro-dispersions to change appearance, channel the flow of light, and provide for hidden illumination. The dye and/or the micro-dispersions can be fluorescent or self-incandescent (i.e., glow-in-the-dark) and can be used with a black (i.e., near ultraviolet) light source. In this implementation, an intermediate layer between dyed portion 710 and reflective layer 720 may not be required. If dyed portion 710 and light source 120 are the same color, then dyed portion 710 inhibits roughened pattern 695 or V-groove 140 from being seen even when light source 120 is illuminated. However, if dyed portion 710 and light source 120 are different colors then roughened pattern 695 and V-groove 140 will be visible when light source 120 is illuminated. Thus, the illumination of objects can be controlled by varying the colors of the dyed portion and the light source.

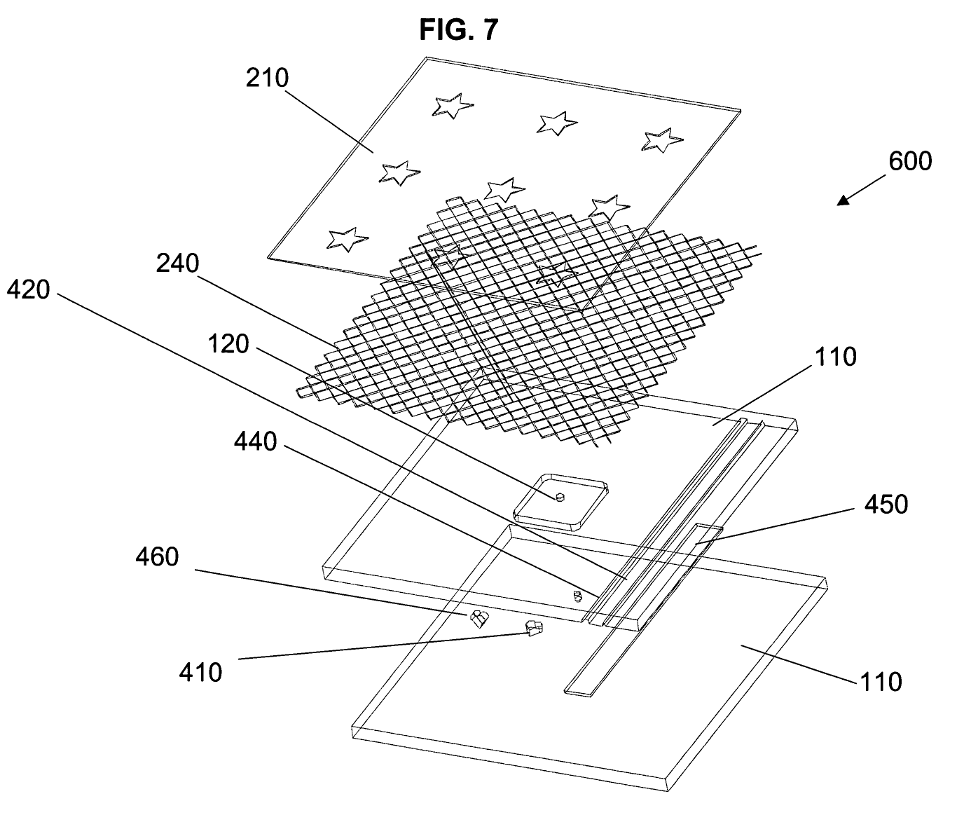

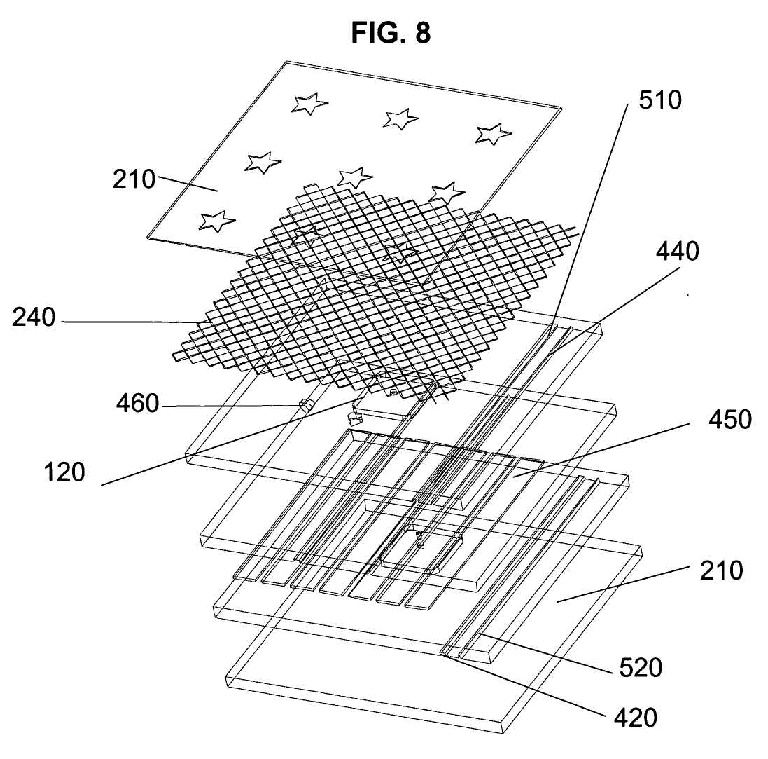

Referring to FIGS. 7-9, in other implementations, body 600 can be formed from any number of transparent layers 110 sandwiched between non-transparent layers 210 and intermediate layers 240. The multiple transparent layers 110 can include any number and configuration of light sources 120 (including light sources having multiple colors), embedded objects 410, 460, grooves 420, 440, 510, 520, 530, 540 and/or electroluminescent sheets 450. The multiple transparent layers will work similarly to the single transparent layer described above, but will provide additional depth and three-dimensionality to the illuminated objects.

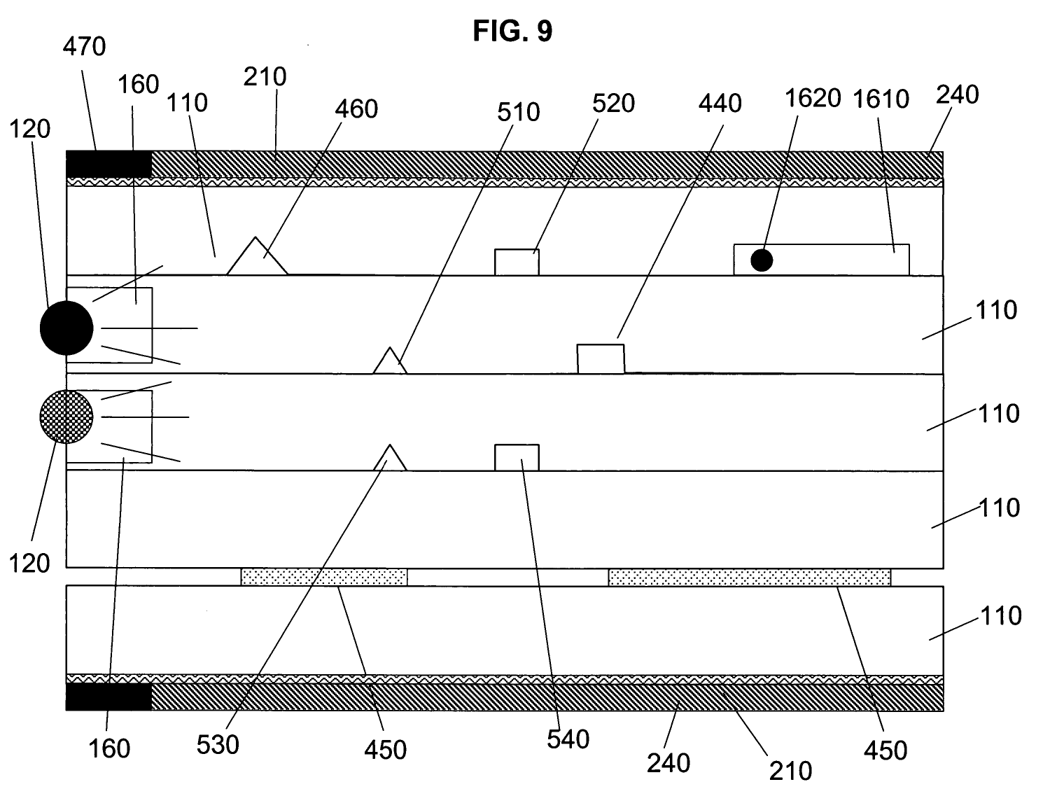

Referring to FIG. 9, transparent layer 110 includes a chamber 1610 containing an object 1620 that is moveable within chamber 1610 and illuminated by light source 120. Chamber 1610 is formed, e.g., by cutting or otherwise forming an aperture in the transparent layer 110. Chamber 1610 also could be surrounded by a transparent or translucent layer. Inside chamber 1610 are one or more objects 1620 that are freely moveable within chamber 1610. Objects 1620 can be passively moveable within chamber 1610 or can be moveable under the control of a motor or magnet. Chamber 1610 is filled, e.g,. with air, but can also be filled with a vacuum or another fluid such as nitrogen, water, or glycerin. Object 1620 is visible from outside guitar 100 when light source 120 is activated to illuminate object 1620. For example, object 1620 can be made of an opaque or reflective material or can be covered with a patterned or roughened surface. Object 1620 also can contain its own light source.

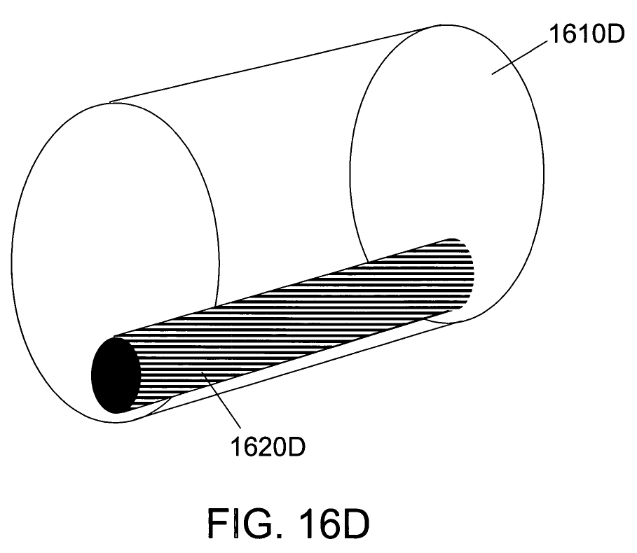

Chamber 1610 and object 1620 can have a wide variety of shapes, numbers, and configurations. For example, referring to FIG. 16A, chamber 1610A has an oval shape and contains a ball shaped object 1620A. Referring to FIG. 16B, chamber 1610B has a rectangular shape and contains a ball-shaped object 1620B. Referring to FIG. 16C, chamber 1610C has a rectangular shaper and contains a pendulum shaped object 1620C that is fixed to chamber 1610C at a fulcrum 1630C. Referring to FIG. 16D, chamber 1610D is cylindrical in shape and contains a rod shaped object 1620D.

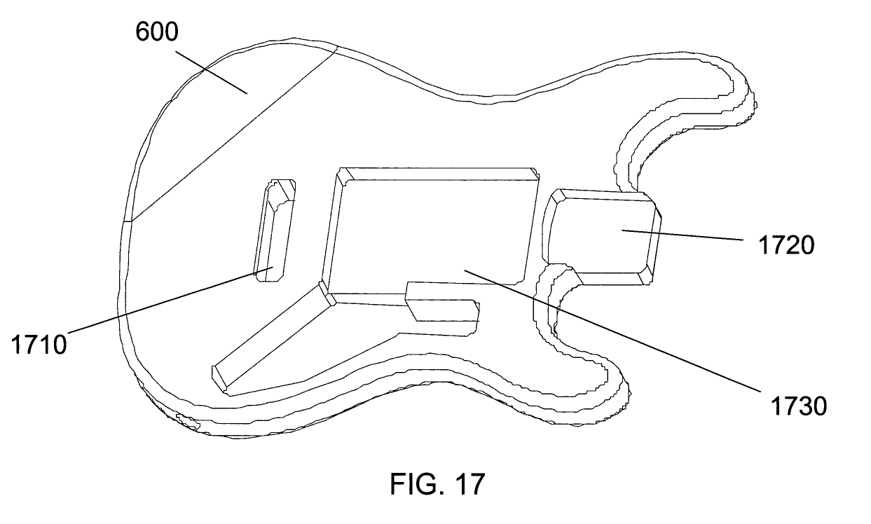

Referring again to FIG. 1, any number of configurations of guitar 100 are possible. For example, one or more of body 600, pickups 610, a body edge 620, tone control knob 640, volume control knob 685, and the pick guard 662 are opaque or mirrored so as to hide the light sources 120 from direct view. Pick guard 662 can be formed from a non transparent layer 210, e.g. a translucent, patterned or reflective layer to hide pattern 695 or the other objects until light source 120 for illumination. Strap holder 655 could contain a light source 120. Neck 660 and head 670 also can be transparent. Tuning pegs 680, volume control knob 685 and tone control knob 640 can contain light sources 120 or can be indirectly illuminated. A patterned translucent surface 710 is positioned on the front or back surface of body 600. Referring also to FIG. 17, a pickup slot 1710 and a neck interface 1720 in body 600 are indirectly illuminated from the light source, which is located inside an electronics bay 1730 underneath the pick guard. Light sources also can be located in pickup slot 1710.

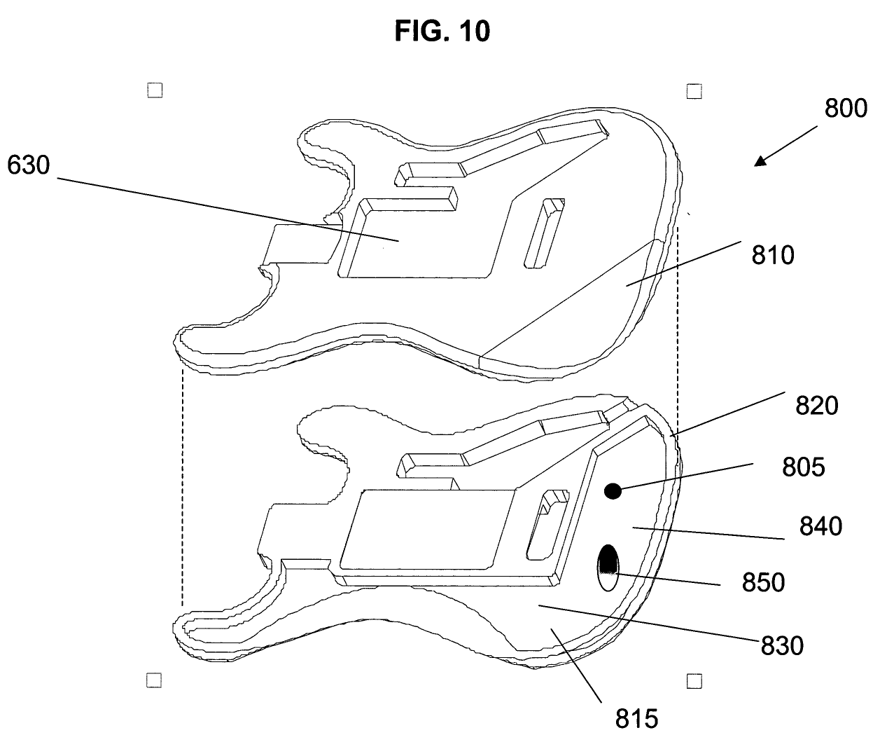

Referring to FIG. 10, in another implementation, a guitar body 800 is formed from a front portion 810 and a back portion 820 that together defined a hollow inner cavity 830 that is sealed closed when front portion 810 and back portion 820 are attached together. An inner surface 840 of hollow cavity 830 can be coated, e.g., with a holographic emulsion 850, for a visual effect. Hollow cavity 830 can be filled with one or more of a vacuum, a gas, a liquid, or a solid. For example, hollow cavity 830 can be filled with liquid dye having two colors swirled together for a pleasing visual effect. In another implementation, hollow cavity 830 is filled with an inert gas, such as argon, helium, or neon. An active electrode 805 is positioned within cavity 830 and return electrode 815 is positioned on inner surface 840 of cavity 830, such as by depositing a thin, metallic coating on inner surface 840. When active electrode 805 is activated, current excites inert gas to form a glowing plasma.

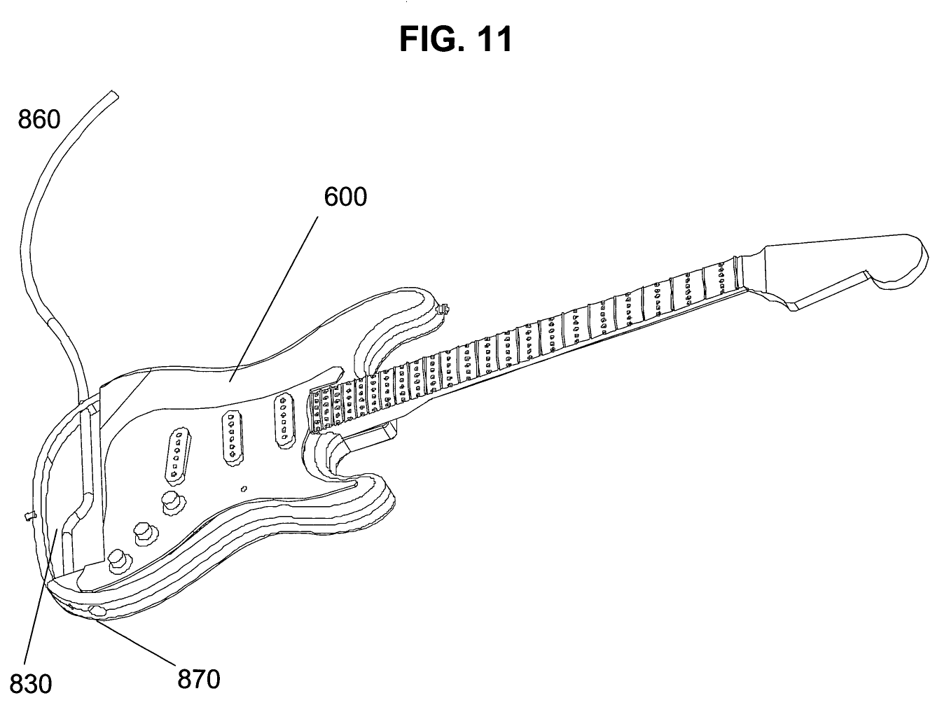

Referring to FIG. 11, hollow cavity 830 can include a drinking straw 860 and a drain/fill port 870. In this implementation, the user may fill the inside of cavity 830 with a beverage and drink the beverage while playing guitar 100.

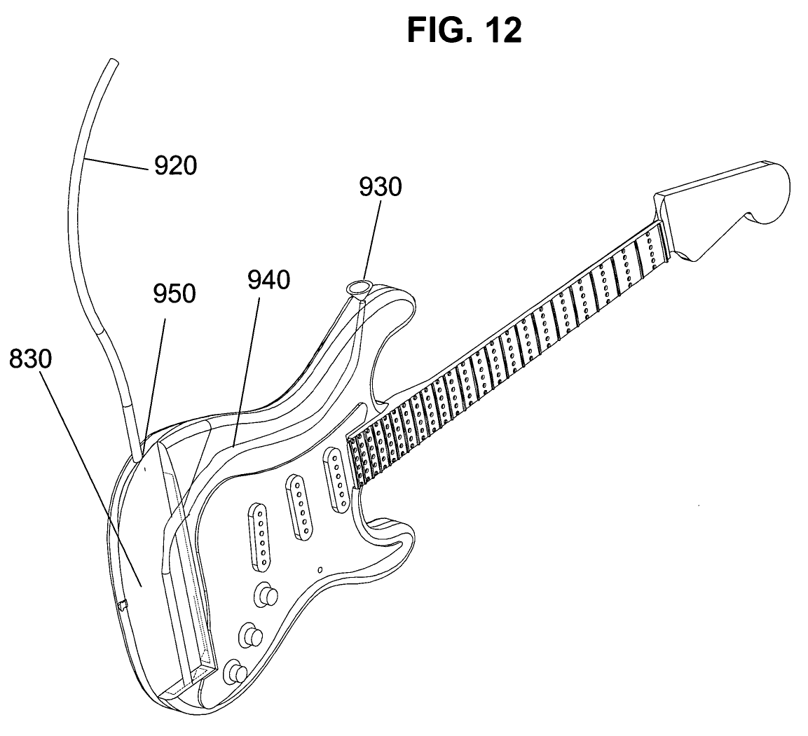

Referring to FIG. 12, hollow cavity 830 is configured to assist in the inhalation of a combustible substance, such as tobacco. Tobacco is inserted into a combustion chamber 930 that is in communication with hollow cavity 830 through a transmission tube 940. Smoke and gases from combustion chamber 930 is carried through transmission tube 940 and are bubbled through liquid contained in the hollow cavity 830. The user can inhale the tobacco through a straw 920 coupled to a port 950 in communication with the hollow cavity 830.

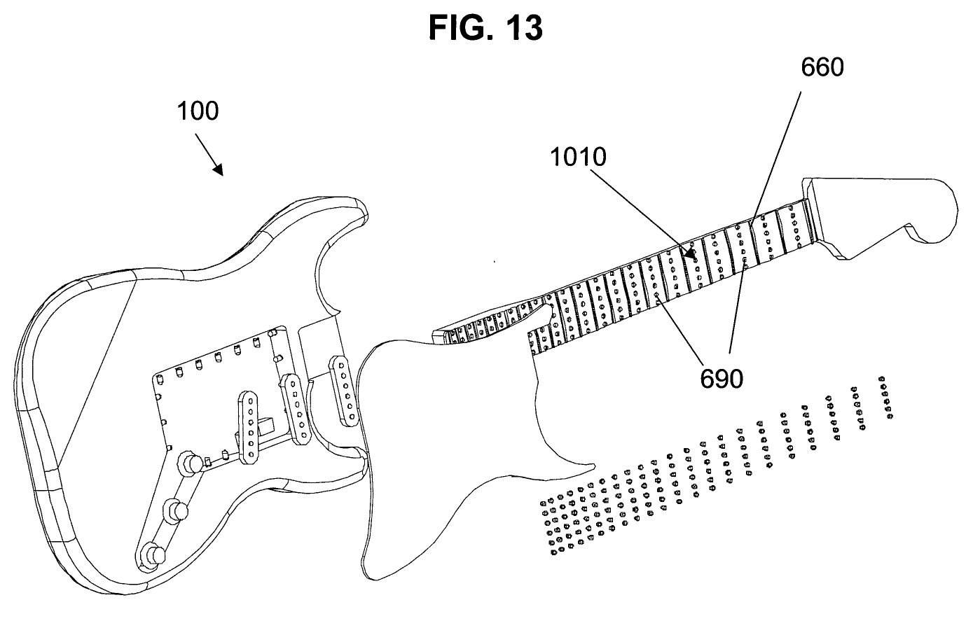

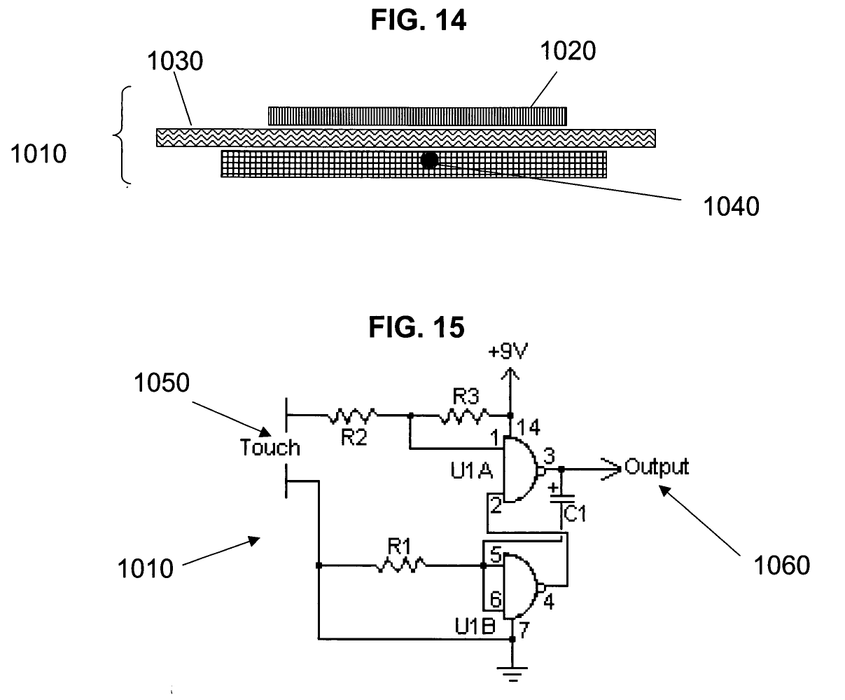

Referring to FIG. 13, in another implementation, one or more triode layer touch switches 1010 that can be coupled to neck 660 of guitar 100 to sense and/or display the user's finger position on frets 690. Referring also to FIG. 14, each touch switch 1010 includes a transparent or patterned opaque electrode 1020 on a transparent, translucent, or patterned supporting surface 1030, over a light source 1040.

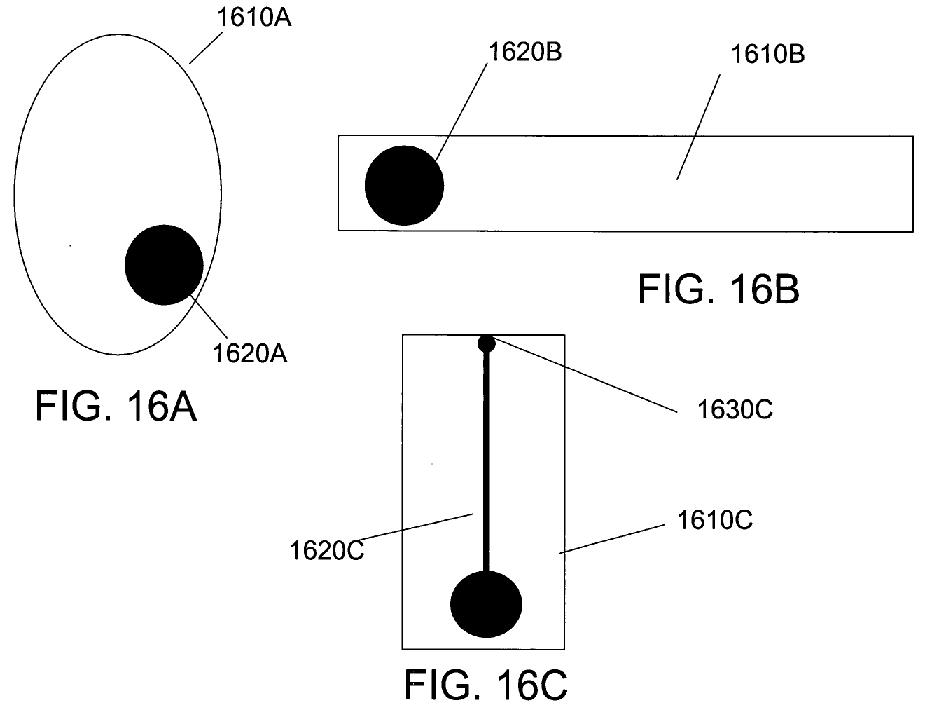

Referring also to FIG. 15, an exemplary circuit diagram of touch switch 1010 is shown, wherein 1050 refers to an electrical switch C1 is a 10 μF 16 V electrolytic capacitor, R1 and R2 are 100 KΩ ¼ Watt resistors, R3 is a 10 MΩ ¼ Watt resistor, and U1 and U2 are 4011 CMOS NAND Gate ICs. When electrical switch 1050 is closed, the output 1060 of the circuit 1010 goes high for about one second to drive the light source 1040. The length of the output pulse can be varied depending on the size of capacitor C1.

A number of implementations have been described. Nevertheless, it will be understood that various modifications may be made. For example, the illumination of objects described above can be used in devices other than musical instruments, such as skateboards, sportsboards, and clothing. These and other implementations are within the scope of the following claims.

1. A musical instrument comprising:
a transparent layer;
an object formed in the transparent layer;
a light source configured to transmit light into the transparent layer to illuminate the object; and
a non-transparent layer over the transparent layer, the non-transparent layer configured to inhibit the object from being seen through the non-transparent layer unless the light source is illuminated.

2. The musical instrument of claim 1 wherein the object comprises a groove in the transparent layer.

3. The musical instrument of claim 1 wherein the object comprises a roughened surface on the transparent layer.

4. The musical instrument of claim 1 wherein the object comprises a hole in the transparent layer.

5. The musical instrument of claim 1 wherein the object comprises a solid object embedded in the transparent layer.

6. The musical instrument of claim 1 further comprising an intermediate layer sandwiched between the transparent layer and the non-transparent layer.

7. The musical instrument of claim 6 wherein the intermediate layer is selected from the group consisting of a gas, a vacuum, a liquid, and a solid spacer.

8. The musical instrument of claim 6 wherein the intermediate layer is configured to inhibit the object from being seen through the non-transparent layer unless the light source is activated.

9. The musical instrument of claim 1 wherein the non-transparent layer comprises a translucent material.

10. The musical instrument of claim 1 wherein the non-transparent layer comprises a layer of a transparent material with an embedded dye or pigment.

11. The musical instrument of claim 1 wherein the non-transparent layer comprises a metal or metal oxide coating.

12. The musical instrument of claim 1, wherein the transparent layer comprises a material selected from the group consisting of glass, acrylic, polystyrene, PET, Plexiglas, Lucite, transparent foam, water, rubbing alcohol, or consumable alcohol.

13. The musical instrument of claim 1 wherein the transparent layer defines a chamber containing a moveable object.

14. The musical instrument of claim 1 wherein the light source is configured to illuminate the moveable object.

15. The musical instrument of claim 1, wherein the light source is selected from the group consisting of an LED, an incandescent bulb, a fluorescent bulb, a plasma light source, a candle, a neon light source, a fiber optic light source, a plasma light source, or an electroluminescent light source.

16. The musical instrument of claim 1, further comprising a removable cartridge that houses the light source.

17. The musical instrument of claim 1, further comprising an electroluminescent sheet that is substantially hidden by the non-transparent layer when not activated and visible through the non-transparent layer when activated.

18. The musical instrument of claim 1 further comprising metallic or non-metallic particulate matter embedded in the transparent layer or the non-transparent layer.

19. The musical instrument of claim 1 wherein the musical instrument is a stringed instrument.

20. The musical instrument of claim 19, wherein the stringed instrument is a guitar.

21. The musical instrument of claim 19, wherein the stringed instrument is a bass.

22. A device comprising:
a transparent layer including an object therein;
a light source configured to illuminate the object;
a non-transparent layer over the transparent layer, wherein the non-transparent layer is configured to inhibit the object from being seen through the non-transparent layer unless the light source is illuminated.

23. A musical instrument comprising:
a transparent layer formed into the body of the musical instrument;
an object formed in the transparent layer;
a translucent layer covering the transparent layer with an air gap between the translucent layer and the transparent layer to inhibit the object from being seen through the translucent layer; and
a light source seated in a recess formed in the transparent layer and covered by an opaque surface, wherein the light source is configured to illuminate the object such that the object can be seen through the translucent layer.

24. A method of selectively illuminating an object formed in a musical instrument, the method comprising:
providing a body of the musical instrument with a transparent layer having the object formed therein and a non-transparent layer over the transparent layer to inhibit the object from being seen; and
activating a light source to transmit light into the transparent layer such that the light illuminates the object while limiting illumination of the transparent layer.

25. A stringed musical instrument comprising:
a neck; and
a body defining a sealed, hollow cavity that is fillable with a gas, a solid, a liquid, or a vacuum.

26. The stringed musical instrument of claim 25 wherein the body comprises a port in communication with the cavity that allows insertion and removal of the solid, the liquid, or the gas.

27. The stringed musical instrument of claim 26 further comprising a tube in communication with the cavity to allow removal of the solid, the liquid, or the gas.

28. The stringed musical instrument of claim 25 wherein the body includes a combustion chamber, a transmission tube in communication with the cavity and the combustion chamber, and a straw in communication with the cavity.

29. The stringed musical instrument of claim 27 wherein the straw allows inhalation of smoke from tobacco being burned in the combustion chamber.

30. A stringed musical instrument comprising:
a neck;
a body defining a sealed, hollow cavity filled with a gas; and
an electrode within the cavity for exciting the gas to form a plasma.
